(19) United States
(12) Patent Application Publication
(10) Pub. No.: US 2008/0281581 A1
(43) Pub. Date: Nov. 13, 2008

(54) METHOD OF IDENTIFYING DOCUMENTS WITH SIMILAR PROPERTIES UTILIZING PRINCIPAL COMPONENT ANALYSIS

(75) Inventors: Philip D. Henshaw, Carlisle, MA (US); Pierre C. Trepagnier, Medford, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SPARTA, INC., Billerica, MA (US)

(21) Appl. No.: 12/116,735

(22) Filed: May 7, 2008

Related U.S. Application Data
(60) Provisional application No. 60/916,480, filed on May 7, 2007.

(51) Int. Cl. G06F 17/27

(52) U.S. Cl. 704/9

(57) ABSTRACT

The present invention generally provides methods and systems for characterizing texts, for example, for identifying textual documents by language, topic, author, or other attributes. In some embodiments, a method of the invention can include creating an n-gram frequency spectrum for a document under analysis, preferably selecting a subset of the n-gram frequency spectrum, transforming the n-gram frequency spectrum into principal component space, and identifying one or more attributes of the document according to its similarity to (or distinction from) reference documents in the principal component space.

### RELATED APPLICATIONS

This application claims priority to a provisional application entitled “Selection of Interrogation Wavelengths in Optical Bio-detection Systems,” having a Ser. No. 60/916,480 and filed on May 7, 2007. This provisional application is herein incorporated by reference.

The present application is also related to a commonly-owned patent application entitled “Selection of Interrogation Wavelengths in Optical Bio-Detection Systems” by Pierre C. Trepagnier, Matthew B. Campbell and Philip D. Henshaw filed concurrently herewith (Attorney Docket No. 101335-36). This concurrently filed application is also incorporated herein by reference in its entirety.

### BACKGROUND

The present invention relates generally to methods and systems for determining characteristics of a text, such as the language or languages in which it is written, its subject matter, or its author.

Traditionally, many document categorization methods have relied on high-level identifiers such as words, sentences, punctuation, and paragraphs for this task (these method are often known as “stylometric”). Depending on the application, these methods, however, have several drawbacks. For example, they depend on natural-language characteristics, and hence they require a linguist or polyglot for initial setup. Further, these methods can be sensitive to misspellings, variants, synonyms, and inflected forms, and they tend to be language specific.

More recently, many researchers have found that features of a text, such as its subject matter or the language in which it is written, can be deduced from the frequency distributions of n-grams, which are defined as runs of n consecutive characters in a text. Unlike stylometric methods, the methods that rely on n-grams frequency distributions do not require that a text under analysis be “understood.” In fact, n-grams frequency distributions can be generated mechanically without a need to understand the text.

The traditional methods utilizing n-grams frequency distributions have shortcomings of their own. For example, due to the large number of possible characters in a text, the potential n-gram space is very large. For example, using the 7-bit ASCII character set, 128⁴=268,435,456 distinguishable 4-grams could in principle be created. Even though most of them are never encountered in practice, in a good sized text several thousand separate 4-grams can appear. This can create a very high-dimensional analysis space in which to classify the text, one which cannot be easily visualized and whose analysis can be computationally intensive.

Accordingly, there is a need for enhanced methods and systems for characterizing texts.

### SUMMARY OF THE INVENTION

The present invention is generally directed to methods and systems for text processing, and particularly to characterizing one or more attributes of a text, such as its language and/or author. In many embodiments, principal component analysis (PCA) can be applied to the n-gram frequency distributions derived from a text under analysis. In general, PCA can produce a set of principal components that are orthonormal eigenvalue/eigenvector pairs, which explain the variance present in a data set. In other words, it projects a new set of axes that best suit the data. In high-dimensional data sets, it is often found that relatively few principal components (PCs) can explain the vast majority of the variance present in a data set. In many embodiments of the present invention for n-gram text classification, it has been found that all important information in n-grams can be found in the first ten or so principal components, in spite of the fact that the raw n-gram frequency distributions can have thousands of variables.

As discussed in more detail below, a further advantage of PCA is that the training aspect of the algorithm (in which the principal component transformation is calculated, and which can be computationally intensive) can be done separately from the analysis of a text under study, which can be accomplished relatively quickly.

In one aspect, the present invention provides a method for characterizing a text, which includes determining frequency distribution for a plurality of n-grams in at least a segment of a text, and applying a principal component transformation to the frequency distribution to obtain a principal component vector in a principal component (PC) space corresponding to the text segment. The principal component vector can be compared with one or more decision rules to determine an attribute of the text segment, such as its authorship, its language and/or its topic.

In a related aspect, the decision rules can be based on assigning different attributes to different regions of the PC space. For example, different regions of the PC space can be associated with different languages, and the language of a text under analysis can be identified by considering in which region the principal component vector associated with the text lies. In some cases, a decision rule can be based on an angle between a reference principal component vector and the principal component vector associated with a text under analysis. For example, a reference principal component vector can be associated with a text authored by a known individual, and that individual can be identified as the author of a text segment under analysis if the angle between a PC vector associated with the text segment and the reference PC vector is less than a predefined value.

In some cases, for each of a plurality of n-gram groupings, frequency distributions for at least two reference texts are determined, where one text exhibits an attribute of interest and the other lacks that attribute. A principal component transformation is performed on each of the frequency distributions so as to generate a plurality of principal component vectors corresponding to the texts for each n-gram grouping, and a metric is defined based on the principal component transformation to rank order the n-gram groupings. By way of example, the metric can be based on a minimum angle between the principal component vectors corresponding to the two reference texts. The n-gram groupings can be rank ordered based on values of the metric corresponding thereto. For example, a higher rank can be assigned to an n-gram grouping associated with a larger minimum angle. Further, one or more n-gram groupings having the highest ranks can be selected for characterizing texts.

In another aspect, a method of comparing two textual documents is disclosed. In such a method, for each of at least two textual documents, the frequency distribution for a plurality of n-grams in at least a segment of the document is determined to generate a frequency histogram of the n-grams. Further, for each document, a principal component transformation is applied to the respective frequency histogram to obtain a principal component vector. At least one attribute (e.g., language or authorship) is compared between the documents based on a comparison of their principal component vectors. For example, the two documents can be characterized as having been written in the same language if an angle between their principal component vectors is less than a predefined value or both vectors lie in a region of the PC space associated with a given language.

In another aspect, the invention provides a system for processing textual data, which includes a module for determining for each of a plurality of n-gram groupings occurrence frequency distribution corresponding to n-gram member of that grouping for at least two reference texts, wherein one text exhibits an attribute of interest and the other lacks that attribute. The system can further include an analysis module receiving the frequency distribution and applying a principal component transformation to that distribution so as to generate a plurality of principal component vectors corresponding to the reference texts for each n-gram grouping. The analysis module can determine, for each n-gram grouping, a minimum angle between the principal components of the texts corresponding to that grouping. Further, the analysis module can rank order the n-gram groupings based on the minimum angles corresponding thereto, e.g., by assigning a higher rank to a grouping that is associated with a larger minimum angle.

Further understanding of the invention can be obtained by reference to the following detailed description, in conjunction with the associated figures, described briefly below.

### BRIEF DESCRIPTION OF THE DRAWINGS

FIG. 1 is a flow diagram depicting various steps in an exemplary embodiment of a method for selecting a subset of wavelengths for use in an optical method for detection of agents in presence of interferents,

FIGS. 2A-2C show the results of applying the method shown in FIG. 1 to an exemplary set of agents {Aᵢ} and a set of interferents {ILᵢ},

FIG. 3 is a flow diagram depicting various steps in another embodiment of a method for selecting a subset of wavelengths,

FIG. 4 shows the results of applying the method shown in FIG. 3 to an exemplary set of {Aᵢ} and {ILᵢ},

FIG. 5A shows a flow chart depicting various steps of the training portion of an exemplary embodiment of a method of the invention for characterizing texts,

FIG. 5B shows a flow chart depicting various steps of an exemplary embodiment of a run-time portion of an exemplary embodiment of a method of the invention for characterizing texts, which utilizes the output of the training portion shown in FIG. 5A,

FIG. 6 shows the result of applying an exemplary implementation of a method of the invention to exemplary sample texts in various languages,

FIG. 7 shows the result of applying an exemplary implementation of a method of the invention to exemplary sample texts written on the subject of baseball by three different authors, and

FIG. 8 schematically shows an exemplary system for implementing the methods of the invention.

### DETAILED DESCRIPTION

The present invention generally provides methods and systems that employ transformation of n-grams frequency distributions of a text into principal component (PC) space for characterizing the text, as discussed in more detail below. In some embodiments, a subset of all possible n-grams is selected that is best suited for characterizing a text under analysis. The selection of such a subset of n-grams is analogous to the selection of a plurality of wavelengths for interrogating a sample as discussed in co-pending patent application entitled “Selection of Interrogation Wavelengths in Optical Bio-detection Systems,” which is herein incorporated by reference. Hence, in the following discussion, initially methods for selecting such wavelengths are discussed, and further details can be in the aforementioned patent application.

As discussed in more detail below, in many embodiments, a metric is defined based on the transformation of spectral data into the principal component space that will allow selecting a subset of excitation wavelengths that provide optimal separation of agents and interferents. The metric can provide a measure of the separation between the principal component vectors of agents and those of the interferents. By way of example, in some embodiments, the metric can be based on spectral angles between the principal component vectors of the agents and interferents.

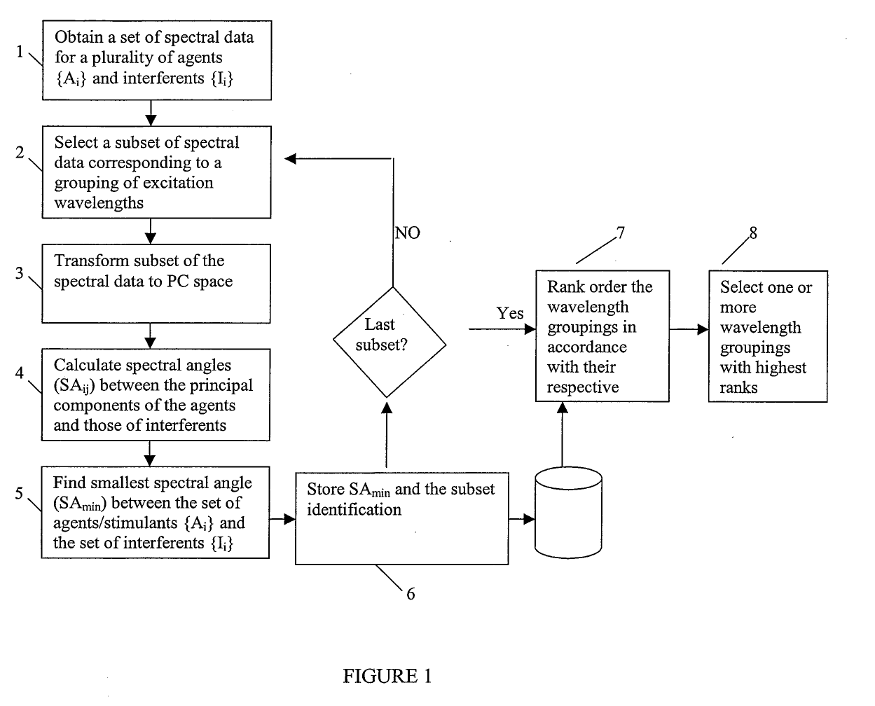

With reference to FIG. 1, in a step (1) of an exemplary embodiment of a method for selection of a subset of wavelengths, a set of spectral data is obtained for a representative sample of agents and/or simulants {Aᵢ} and interferents {Iᵢ}. In this exemplary embodiment, the spectral data correspond to fluorescence excitation-emission spectra and fluorescence liftetime data (herein referred to as XML data or measurements). As noted above, the teachings of the invention can be applied not only to XML data but other types of data, such as, optical reflectance and/or scattering measurements, laser-induced breakdown spectroscopy (LIBS) spectra, Raman spectra, or Terahertz transmission or reflection spectra, etc.

In a subsequent step (2), for each of the agents and interferents, a subset of the spectral data corresponding to a grouping of excitation wavelengths is chosen. The number of wavelengths in each grouping can correspond to the number of optical wavelengths whose selection is desired. For instance, consider a case in which there are 20 excitation wavelengths in a full set of XML data, and the best four wavelengths (i.e., the four wavelengths out of 20 that provide optimal results) need to be identified. As the number of combinations of 20 things (here wavelengths) taken four at a time Cⁿₖ with n=20 and k=4 is 4845, there are 4845 distinct 4-member groupings of the wavelengths. These combinations can be ordered according to some arbitrary scheme, pick the first one, and move to step (3).

In step (3), a principal component transformation is applied to this subset of the data corresponding to a respective wavelength grouping to transform the data in each subset into the principal component (PC) space. The calculation of the principal component transformation can be performed, e.g., according to the teachings of copending patent application entitled “Agent Detection in the Presence of Background Clutter,” having a Ser. No. 11/541,935 and filed on Oct. 2, 2006, which is herein incorporated by reference in its entirety. The principal component analysis can provide an eigenvector decomposition of the spectral data vector space, with the vectors (the “principal components”) arranged in the order of their eigenvalues. There are generally far fewer meaningful principal components than nominal elements in the data vector (e.g., neighboring fluorescence wavelengths can be typically highly correlated). In many embodiments, only meaningful PC vectors are retained. Many ways to select those PC vectors to be retained are known in the art. For example, a PC vector can be identified as meaningful if multiple measurements of the same sample (replicates) continue to fall close together in the PC space. In many bio-aerosol embodiments, the number of meaningful PC vectors can be on the order of 7-9, depending on the exact nature of the data set.

The principal component transformation of the subset of spectral data corresponding to an agent or an interferent generates a principal component vector for that agent or interferent associated with that subset of data and its respective excitation wavelengths. In this manner, for the wavelength grouping, a set of principal component vectors are generated for the agents {Aᵢ} and a set of principal component vectors are generated for the interferents {Iᵢ}.

In step (4), for the selected wavelength grouping, spectral angles (SAᵢⱼ) (index i refers to agents and j to interferents) between the principal component vectors of the agents and those of the interferents, obtained as discussed above by applying a principal component transformation to the spectral data associated with that wavelength grouping, are calculated. By way of example, the spectral angle between two such principal component vectors a and b (that is, between an agent vector and an interferent vector) can be defined by utilizing the normalized dot product of the two vectors as follows:

$$S A ( a , b ) = {cos}^{- 1} [ \frac{a \cdot b}{\vert a \vert \vert b \vert} ] \qquad Eq . ( 1 )$$

wherein

a.b represents the dot product of the two vectors,

|a| and |b| represent, respectively, the length of the two vectors

In many cases the principal component vectors are multi-dimensional and the above dot product of two such vectors (a and b) is calculated in a manner known in the art and in accordance with the following relation:

a.b=a₁b₁+a₂b₂+ . . . +aₙbₙ Eq. (2)

wherein

(a₁, a₂, . . . , aₙ) and (b₁, b₂, . . . , bₙ) refer to the components of the a and b vectors, respectively.

Further, the norm of such a vector (a) can be defined in accordance with the following relation:

|a|=\sqrt{|a₁|²+|a₂|²+ . . . +|aₙ|²} Eq. (3)

Further details regarding the calculation of spectral angles between principal component vectors can be found in the aforementioned patent application entitled “Agent Detection in the Presence of Background Clutter.” This patent application presents a rotation-and-suppress (RAS) method for detecting agents in the presence of background clutter in which such spectral angles act as the metric of separability, with a SA of 90° (orthogonal) corresponding to the easiest separation.

The spectral angles between the agent vectors and the interferent vectors are used herein to define a metric (an objective function) for selecting an optimal grouping of excitation wavelengths. In particular, with continued reference to the flow chart of FIG. 1, in step (5), for the wavelength grouping, the smallest spectral angle between the set of agents and/or simulants {Aᵢ} and the set of interferents {Iᵢ} is chosen as the objective function. The smallest angle, which is herein denoted by SAₘᵢₙ, represents the “worst case scenario,” in the sense of offering the poorest separation between an agent and interferent. The “smallest angle” is herein intended to refer to an angle that is the farthest from orthogonal, so that SAs greater than 90° are replaced by 180°-SA.

In step (6), the SAₘᵢₙ for the data subset is stored, e.g., in a temporary or permanent memory, along with a subset identifier (an identifier that links each subset (distinct wavelength grouping) with a SAₘᵢₙ associated therewith).

The same procedure is repeated for all the other wavelength groupings and their associated data subsets, with the SAₘᵢₙ of each wavelength grouping identified and stored. In many implementations, the calculations of all SAₘᵢₙs can be done via an iterative process (after calculating an SAₘᵢₙ, it is determined whether any additional SAₘᵢₙ(s) need to be calculated, and if so, the calculation(s) is performed—with modern digital computers, an exhaustive search is not prohibitive, although clearly various empirical hill-climbing techniques, genetic algorithms and the like could be used. In particular, such techniques are particularly useful in the methods of text characterization discussed below, where the number of possible n-grams can be in the thousands rendering in many cases exhaustive searches prohibitive.

Once all the SAₘᵢₙs are calculated (e.g., in the case in which there are 20 excitation wavelengths there would be 4845 SAₘᵢₙs), they can be compared as discussed below to identify the “optimal” wavelength grouping.

In step (7), the wavelength groupings (data subsets) are rank ordered in accordance with their respective SAₘᵢₙs with higher ranks assigned to those having greater SAₘᵢₙs. In other words, for any two wavelength groupings the one that is associated with a greater SAₘᵢₙ is assigned a greater rank. A higher rank is indicative of providing a better spectral separation between the agents and interferents.

In step (8), one or more of the wavelength groupings with the highest ranks can be selected for use as excitation wavelengths in optical detection methods, such as those disclosed in the aforementioned patent application entitled “Agent Detection in the Presence of Background Clutter.” For example, in the above example in which four wavelengths from a list of 20 need be selected the “best” set of four wavelengths can be computed, in the sense of those that give the best separation between agents and interferents. In some cases, the SAₘᵢₙ computed for the full ensemble of wavelengths (e.g., 20 in the above example) as well as SAₘᵢₙ computed for a subset of the wavelengths (e.g., 4 in the above example) can be utilized to obtain a direct, quantitative measure of the extent by which the selection of the subset of the wavelengths can effect differentiation of agents and interferents in the PC space.

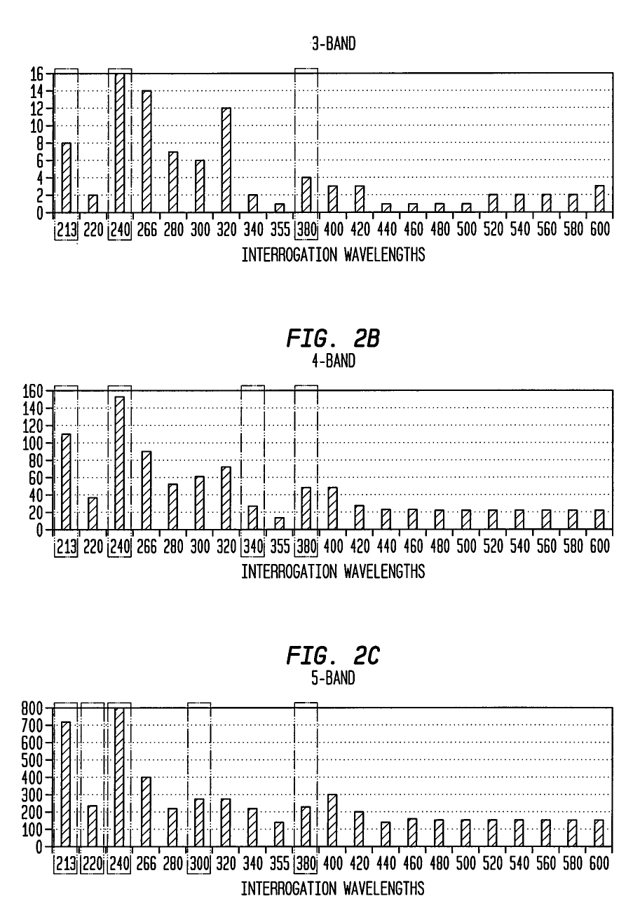

By way of illustration, the results of applying the wavelength selection embodiment depicted in FIG. 1 to an actual exemplary data set are shown in FIGS. 2A-2C. The data set is small, comprising 4 simulants {Aᵢ} and 4 interferents {ILᵢ}, but it will serve to illustrate the methodology. The results for the best three, four, and five interrogation wavelengths are shown, respectively, in FIGS. 2A, 2B, and 2C. More specifically, the graph is FIG. 2A shows the result for three interrogation wavelengths, labeled “3-Band,” the graph in FIG. 2B the result for four, and the graph in FIG. 2C the result for five interrogation wavelengths. The x axis in each graph shows the interrogation wavelengths, which in this example include 21 wavelengths, extending from 213 nm to 600 nm. For each of the three, four, and five interrogation wavelengths, the combinations are rank-ordered by SAₘᵢₙ and histograms are plotted of the top 10% of the combination of n wavelengths taken k at a time, where n is 21 and k is (3, 4, and 5) in this case. Thus, there will be 3 histogram entries for each combination in the 3-Band case, four for the 4-Band case, and five for the 5-Band case. These histograms give an idea of the robustness of the method, but the largest histogram bins need not correspond to the best SAₘᵢₙ. The actual optimal result is shown in each case as k hollow, diagonally-shaded boxes around the chosen wavelengths. Due to the small size of the data set, the results are not completely stable, and in particular the solution is apparently vacillating between 300 and 340 in the 4- and 5-Band case. However, the general trend is clear, and given the broadness of fluorescence features, wavelengths between 300 and 340 are highly correlated, so that result is not surprising.

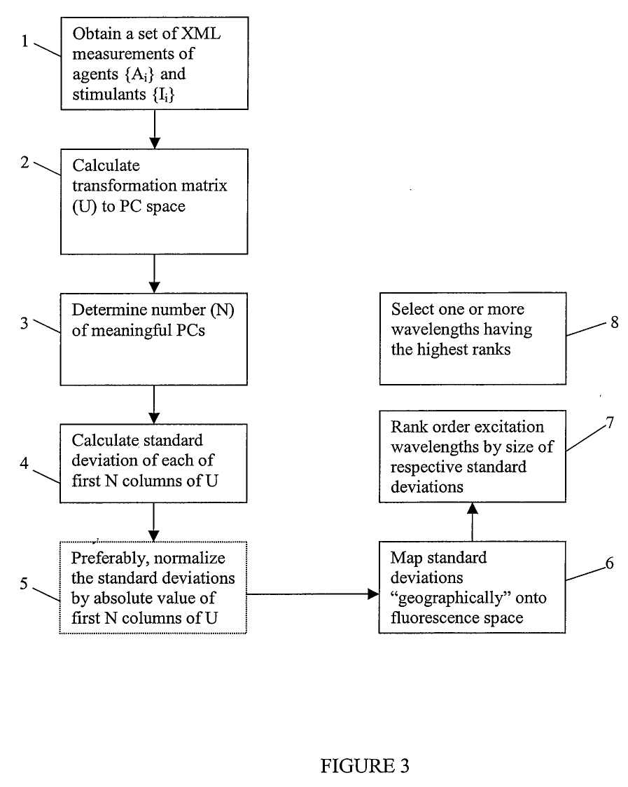

FIG. 3 depicts a flow chart providing various steps of an alternative embodiment of a method for selecting an optimal set of interrogation wavelengths. This embodiment has the advantage of being in many cases less computationally intensive than that discussed above in connection with FIG. 1. Considering the transformation of spectral data to PC space: PC=X·U, where X is the spectral data space, U the PC transformation matrix (typically calculated using singular value decomposition), and PC the principal component space. For a given data vector X, there is a matching coefficient U which multiplies it to create a PC vector. Thus, the coefficients making up U can be displayed in the same space as X with a one-to-one mapping. This mapping technique is utilized, e.g., in the field of metrology, where the principal component coefficients are plotted on the geographical grid points from the X data points are taken. Further details of such mapping can be found in “Principal Component Analysis” by I. T. Jolliffe published by Springer-Verlag, New York (1986), which is herein incorporated by reference.

An analogous mapping in fluorescent excitation-emission analysis can be implemented by plotting the U coefficients back “geographically” onto the locations in the two-dimensional excitation-emission fluorescence space. For example, a linear vector X in spectral data space can be unwrapped from the two-dimensional excitation-emission space according to some regular scheme, for instance, by starting at the shortest excitation wavelength and taking all emission wavelengths from the shortest to the longest, then moving to the next shortest excitation wavelength, and so forth. This scheme can be simply inverted to map the columns of U back into the excitation-emission space.

The transformation matrix U will have a column for every meaningful PC (e.g. 7 columns for 7 meaningful PCs in an exemplary data set), and hence 7 re-mapped excitation-emission plots of the coefficients of U exist, one for each PC. In the present embodiment, however, rather than employing the coefficients of U, the standard deviation σ of the coefficients (e.g., row-wise, across PC number) are utilized. As discussed above, principal component analysis (PCA) can be employed to reduce the dimensionality of a data set, which can include a large number of interrelated variables, while retaining as much of the variation present in the data set as possible. More specifically, applying a principal component transformation to the data set can generate a new set of variables, the principal components, which are uncorrelated and which are ordered so that the first few retain most of the variation present in all the original variables.

As such, if the underlying spectral data at any single excitation-emission point in X were always constant, then no variation would have to be explained, and the corresponding coefficient of U would be zero for all columns. At the other extreme, if any single excitation-emission point were completely uncorrelated with any other excitation-emission point, then it would itself represent irreducible variation and its weight would appear entirely in one column of U. In the former case, the row-wise standard deviation σ of the coefficients would be zero, while in the latter it would be large. Thus, in this embodiment the row-wise standard deviation vector σ (with as many rows as U, but only 1 column) is utilized as a metric for the amount of variation exhibited by its corresponding spectral data, although other metrics of variation could also be used, e.g. variance or range.

As the data set in question can be a representative sample of agents and/or simulants {Aᵢ} and interferents {Iᵢ}, plotting the vector σ “geographically” back into excitation-emission space will give a measure of how much each area of the excitation-emission spectrum of that space contributes to discrimination between the agents and the interferent.

FIG. 3 schematically depicts an exemplary implementation of the alternative embodiment for selecting an optimal set of wavelengths. In step (1), a set of XML measurements of a representative sample of agents and/or simulants {Aᵢ} and interferents {Iᵢ} is obtained.

In a subsequent step (2), a transformation matrix (U) for effecting principal component transformation is calculated for the data set, e.g., in a manner discussed above and the data is transformed into that principal component (PC) space. As noted above, further details regarding principal component transformation can be found in the teachings of the aforementioned pending patent application “Agent Detection in the Presence of Background Clutter.” In step (3) the number of meaningful (non-noise) PC vectors is identified. In general, only meaningful PC vectors are retained. In many bio-aerosol fluorescence cases, the retained PC vectors can be on the order of 7-9, depending on the exact nature of the data set. The number of meaningful PCs is herein denoted by N.

In step (4), the standard deviations of the coefficients of the first N columns of transformation matrix U are calculated, as discussed above. In some implementations, the standard deviations are then normalized (step 5), e.g., by the mean value of U to generate fractional standard deviations. In alternative implementations, the normalization step is omitted.

In step (6), the standard deviations are mapped back onto the excitation-emission space, e.g., in a manner discussed above. The excitation wavelengths can be rank ordered (step 7) based on standard deviations, with the wavelengths associated with larger standard deviations attaining greater ranking. The excitation wavelengths that correspond to the largest values of the standard deviations, that is, the one having the highest ranks, are then selected (step 8).

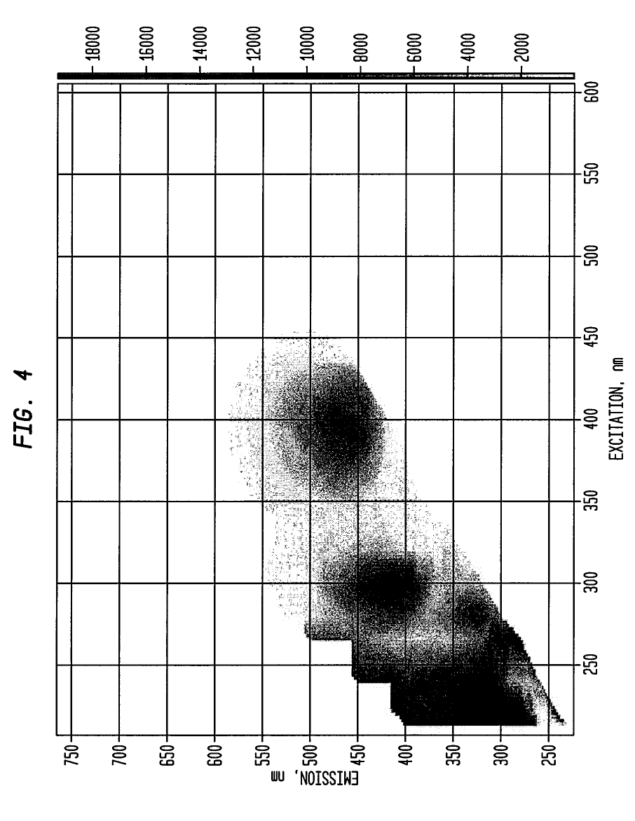

FIG. 4 shows the results of applying the method of the above alternative embodiment discussed with reference to FIG. 3 to the same data set as was used in FIGS. 2A-2C (that is, the output of box 6 in FIG. 3). The row-wise standard deviation of U is shown in grayscale, with black representing the largest values and white the smallest. The bar on the right hand side shows the grayscale corresponding to a given value of σ. The excitation wavelengths are represented by the darkest hues (i.e., the ones that are associated with the largest σ) are seen to generally correspond to those selected by the method of FIG. 1. However, this method is much less computationally intensive than that of FIG. 1 as it does not require thousands of sets of computations, one for every possible combination.

Turning again to describing exemplary embodiments of the methods and systems of the invention for text processing, a classifier is initially determined for a training corpus of texts. As discussed in more detail below, the determination of the classifier can include transforming distributions of n-grams in the training texts into the principal component (PC) space and identifying regions of the PC space with which the relevant types of texts are associated. The classifier can then be utilized to classify a new text. In many embodiments, the classifier is generated once (e.g., off-line) and then utilized multiple times to classify a plurality of new texts (e.g., at run-time). In the following description, the generation of the classifier and its associated parameters is also referred to as the training step, and the use of the classifier to classify texts is in some cases referred to as the on-line (or run-time) step.

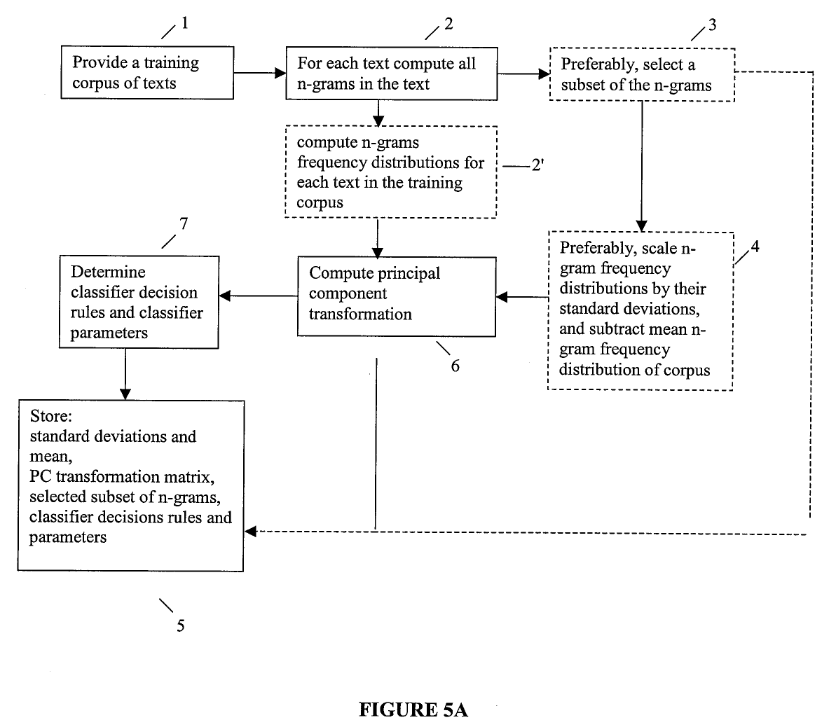

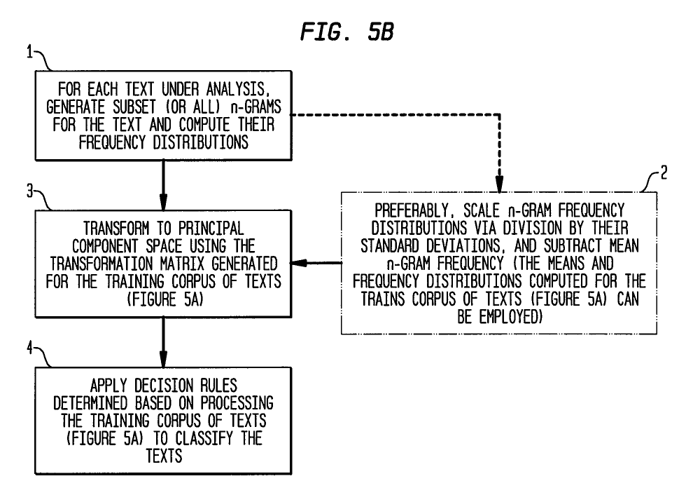

More specifically, with reference to FIG. 5A, in step (1), a training corpus of texts is provided based on which a classifier can be determined. The term “training corpus of texts” as used herein denotes a statistically-significant set of texts that are representative of the universe of texts whose classification is desired. For example, if the classification relates to identifying the language of texts, the training corpus can include texts from a variety of languages. For example, representative texts in English, German, Italian, among others, can be employed to associate each language with a different portion of the PC space, as discussed further below. Alternatively, when the classification relates to identifying the authorship of texts, the training corpus can include texts from different authors.

Assuming there are N texts in the corpus, in step 2, for each text Ti, where i runs from 1 to N, frequency distributions for all n-grams in the text are computed. The term “n-gram” is known in the art, and refers to consecutive sequence of n characters. By way of example, a 2-gram refers to consecutive sequence of 2 characters, such as {ou} or {aw}, and a 3-gram refers to consecutive sequence of 3 characters, such as {gen} or {the}. In some embodiments, punctuation marks, such as comma or semicolon are also considered as characters to be included in the n-grams. In some cases, the frequency distribution of an n-gram can be determined by simply bumping a counter for each n-gram encountered, then dividing by the total number of characters (i.e. 1-grams) in T. Generally, in the corpus {Tᵢ}, many thousands of distinct n-grams will appear.

Preferably, in some cases, in step 3, a subset of the n-grams can be selected according to some criterion for use in the subsequent steps. By way of example, in some cases, a minimum frequency cut-off can be employed to select a subset of the n-grams (the n-grams whose occurrence frequencies are less than the minimum would not be included in the subset). Further details regarding such a frequency cut-off criterion can be found in an article entitled “Quantitative Authorship Attribution: Δn Evaluation of Techniques,” authored by Jack Grieve and published in Literary and Linguistic Computing, v. 22, pp. 251-270 (September 2007), which is herein incorporated by reference in its entirety.

More preferably, in some cases, the method discussed above for selection of an optimal subset of wavelengths can be adapted to select a subset of n-grams. More specifically, n-grams can be treated completely analogously to the interrogation wavelengths discussed above with the subset of n-grams retained being chosen according to a criterion which maximizes separation in the PC space. For example, in cases in which classification of texts based on their language is desired, a subset of n-grams that maximizes separation between principal component vectors corresponding to different languages can be chosen.

In some implementations, the mean and standard deviation of the N n-gram frequency distributions, one for each text Tᵢ, previously found, are computed, and for each of the n-gram frequency distributions, the mean distribution is subtracted from that n-gram frequency distribution (this operation is referred to as “mean-centering” in the PCA literature), and the result is divided by the standard deviation to generate a scaled frequency distribution (step 4). Further, the mean and the standard deviation of the n-gram frequency distributions can be stored (step 5) for subsequent use in processing texts. In other implementations, the n-gram frequency distributions are employed in subsequent steps discussed below without such scaling.

In step 6, a PC transformation is computed from the mean-centered and scaled n-gram frequency distributions, e.g., by utilizing the method of singular value decomposition known in the art. The locations of the various classes under study are then identified in step 7. For example, in case of generating a classifier for identifying texts written in different languages, correspondence of different portions of the PC space with different languages is identified. In general, a decision methodology, e.g., linear discriminant analysis or one based on spectral angles, or the like are identified for application to transformation of texts {T} under analysis in the PC space. For example, the decision methodology can be based on comparing the angle between a PC vector of a text under analysis and a PC vector corresponding to a reference text with a predefined threshold value (a decision parameter). The selected subset of n-grams, together with mean and standard deviation of the n-gram frequencies, the PC transformation matrix, and the decision parameters, determined based on the “off-line” training corpus are all saved (step 5), e.g., in a memory, so that they can be applied to the “on-line” test cases.

With continued reference to FIG. 5A, in some implementations, the above steps (3) and (4) can be omitted and n-grams frequency distributions for each text in the training corpus can be computed (step 2′). Subsequently, a principal component transformation can be computed for the n-grams frequency distributions (step 6), and the classifier decision rules and parameters can be determined (step 7). The PC transformation and the classifier decision rules and parameter can be stored (step 5).

Turning to FIG. 5B, various steps of an exemplary embodiment of a method according to the invention for classifying one or more texts are depicted in which a previously determined classifier can be employed to characterize texts under analysis. For each text under analysis, in step 1, the respective n-grams can be generated, and converted to frequency distributions by dividing by the number of characters in the text. More specifically, the n-grams for which frequency distributions are generated correspond to the n-grams which were created previously in the training step (the n-grams to which PC transformation was applied in FIG. 5A to obtain classifier parameters) so that the principal component transformation generated and saved in the training step can now be applied to the n-gram frequency distributions corresponding to a text under analysis.

In some implementations, in step 2, an n-gram frequency distribution for the text under analysis can be preferably offset and scaled by the factors previously determined in the off-line training step 3, e.g., it can be offset by the mean and is scaled by the standard deviation determined for the training corpus of texts.

In step 3, the n-gram frequency distributions of the text under analysis, which has been preferably offset and scaled, are transformed into principal component space, utilizing the transformation matrix determined based on the corpus of the training texts off-line during the training step (FIG. 5A). In some implementations, the scaling step 2 is omitted, and the PC transformation is applied to the n-grams frequency distribution determined in step (1).

In step 4, the decision rules previously determined in the off-line training step can be used to classify the text. For example, the location of a principal component vector (FIG. 5A) associated with a text under analysis in the PC space can be utilized, together with the previously defined decision rules, to identify the language of the text. By way of example, if the vector lies within a portion of the PC space associated with texts in English, the language of the text under analysis can be identified as English.

The above process for classifying a text can be performed efficiently as all the relevant parameters (e.g., the transformation matrix, decision rules) other than the n-gram frequencies are determined off-line and saved.

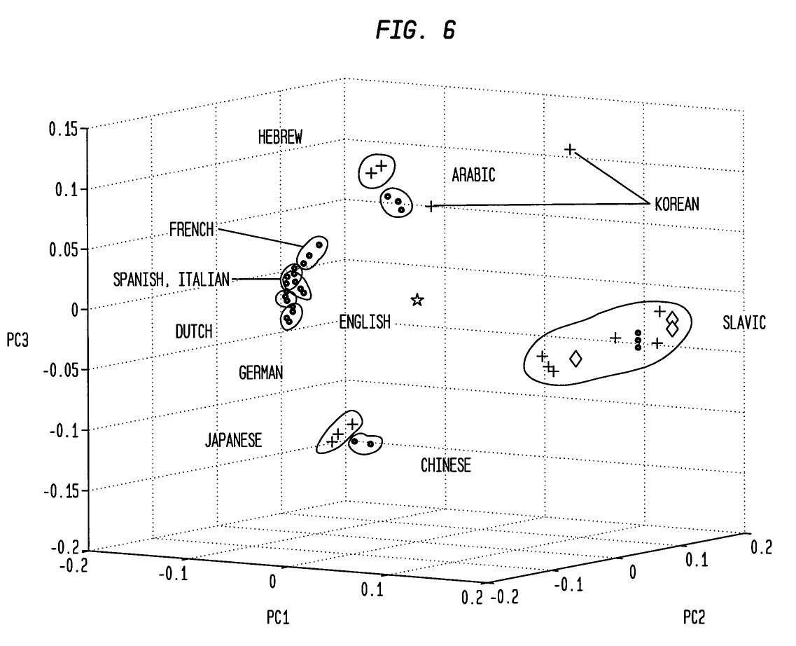

By way of illustration and only to show the efficacy of the methods of the invention for classifying texts, FIG. 6 shows the result of applying a method according to an embodiment of the present invention to classify sample texts written in different languages. Single characters frequencies and 2-gram frequencies were utilized as input to the analysis. The texts are plotted in the space of the first three PC coordinates only. The language samples of about 1000 words length were obtained from Wikipedia, and are neither on the same topic nor written by the same author. FIG. 6 shows that the language of a text can be readily identified even from short samples of text and even when the character set is the same for a group of languages. In many cases, the language of a text sample can be the most important factor in determining single character and 2-gram frequencies. An interesting aspect of FIG. 6 is how the different languages group by linguistic family (e.g. Romance and Germanic languages). Note also that the clustering is evident in the first three principal components, although the original n-gram vector space had several thousand dimensions.

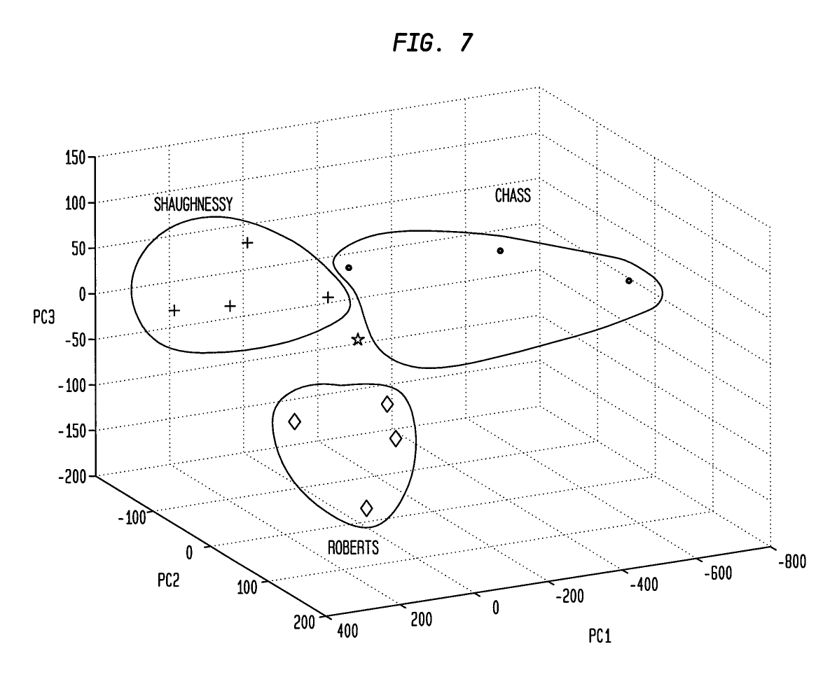

For a text in which the language and subject were the same, it was found that short samples of text clustered by author. By way of illustration, FIG. 7 depicts the result of applying the teaching of the present invention to texts by different authors on the same topic. Four samples of text from each of three different sportswriters writing on baseball were analyzed using principal component analysis. These text samples were each about 1000 words long. In this case, both 1- and 2-gram frequencies, and the counts in each category were normalized by a standard deviation estimate derived from the predicted letter frequencies in English as a whole (rather than from the small corpus under study). Even with a small corpus, FIG. 7 shows the three authors could be separated by linear discriminant analysis.

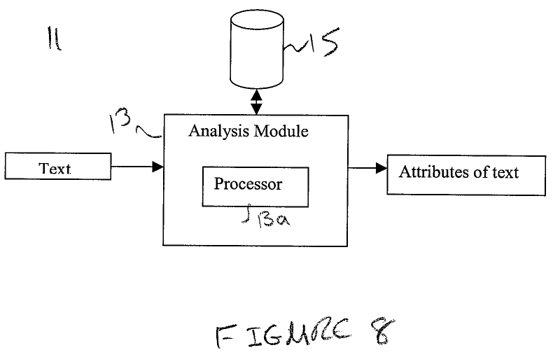

The methods of the invention for characterizing texts can be implemented via a variety of different systems. By way of example, FIG. 8 shows an exemplary embodiment of one such system 11, which includes an analysis module 13 that receives one or more texts at its input and provides one or more attributes of the text(s) (e.g., language and/or author) at its output. More specifically, the analysis module can access from a memory 15 classifier decision rules and parameters as well as PC transformation previously determined for a corpus of training texts (e.g., by the analysis module itself), and applies the methods discussed above, e.g., in connection with FIG. 5B, to the text under analysis. The analysis module can be implemented in hardware and software in a manner known in the art to implement the methods of the invention for classifying texts. By way of example, the analysis module can include a processor 17 and ancillary circuitry (e.g., random access memory (RAM) and buses) that can be configured in a manner known in the art to carry out various steps of the methods of the invention for classifying a text.

It should be understood that various changes can be made to the above embodiments without departing from the scope of the invention.

The teachings of the following references are herein incorporated by reference:
1. Damashek, Marc, “Gauging Similarity with n-Grams: Language-Independent Categorization of Text,” Science v. 267 pp. 843-848 (10 Feb. 1995)
2. Grieve, Jack, “Quantitative Authorship Attribution: Δn Evaluation of Techniques,” Literary and Linguistic Computing, v. 22 pp. 251-270 (September 2007)
3. Frantzeskou, Georgia, et al., “Identifying Authorship by Byte-Level N-Grams: The Source Code Author Profile (SCAP) Method,” International Journal of Digital Evidence v. 6 no. 1 (2007)
4. U.S. Pat. No. 5,418,951 (Damashek), issued May 23, 1995
5. U.S. Pat. No. 5,752,051 (Cohen), issued May 12, 1998

Those having ordinary skill in the art will appreciate that various modifications can be made to the above embodiments without departing from the scope of the invention.

1. A method of characterizing a text, comprising
determining frequency distribution for a plurality of n-grams in at least a segment of a text,
applying a principal component transformation to said frequency distribution to obtain a principal component vector in a principal component space corresponding to said text segment.

2. The method of claim 1, further comprising comparing said principal component vector with one or more predefined decision rules to determine an attribute of said text segment.

3. The method of claim 1, wherein said one or more decision rules are based on assigning different attributes to different regions in principal component space.

4. The method of claim 2, wherein said attribute corresponds to an authorship of said text segment.

5. The method of claim 2, wherein said attribute corresponds to language of said text segment.

6. The method of claim 2, wherein said attribute corresponds to a topic of said text segment.

7. The method of claim 2, wherein at least one of said decision rules is based on an angle between the principal component vector corresponding to said text segment and said reference principal component vector.

8. The method of claim 7, wherein said reference principal component vector is associated with text authored by a known individual.

9. The method of claim 8, further comprising identifying said individual as the author of the text segment if said angle is less than a predefined value.

10. The method of claim 7, wherein said reference principal component vector is associated with text written in a given language.

11. The method of claim 10, further comprising identifying said given language as the language of the text segment if said angle is less than a predefined value.

12. The method of claim 1, wherein said n-grams comprise diagrams.

13. The method of claim 1, wherein said n-grams comprise individual characters.

14. The method of claim 2, further comprising
determining, for each of a plurality of n-gram groupings, frequency distribution for at least two reference texts, wherein one text exhibits an attribute of interest and the other lacks said attribute,
performing a principal component transformation on each of the frequency distributions so as to generate a plurality of principal component vectors corresponding to said texts for each n-gram grouping,
defining a metric based on said principal component transformation to rank order said n-gram groupings,
rank ordering said n-gram groupings based on values of the metric corresponding thereto.

15. The method of claim 14, further comprising selecting an n-gram grouping having the highest rank.

16. The method of claim 15, further comprising utilizing said n-gram grouping to characterize the text.

17. The method of claim 14, wherein said metric comprises a minimum angle between the principal component vectors corresponding to said two reference texts.

18. The method of claim 17, further comprising assigning a higher rank to an n-gram grouping having a larger minimum angle.

19. The method of claim 18, further comprising selecting one or more n-gram groupings having the highest ranks as said plurality of distinct n-grams for characterizing said text segment and utilizing at least one of the principal component vectors associated with one of said reference texts as said reference principal component vector.

20. A method of comparing two textual documents, comprising
for each of at least two textual documents, determining frequency distribution for a plurality of n-grams in at least a segment of said document to generate a frequency histogram of said n-grams,
for each document, applying a principal component transformation to said frequency histogram to obtain a principal component vector, and
comparing at least an attribute of said documents based on a comparison of said principal component vectors.

21. The method of claim 20, further comprising determining an angle between said principal component vectors.

22. The method of claim 21, further comprising comparing authorship of said documents based on said angle.

23. The method of claim 22, further comprising the step of characterizing the documents as having the same author if said angle is less than a predefined value.

24. The method of claim 21, further comprising comparing language of said documents based on said angle.

25. A method of selecting a plurality of n-grams for processing a text, comprising
determining, for each of a plurality of n-gram groupings, frequency distribution for at least two reference texts, wherein one text exhibits an attribute of interest and the other lacks said attribute,
for each n-gram grouping, performing a principal component transformation on the frequency distributions of that grouping for said texts so as to generate a plurality of principal component vectors for said texts,
for each n-gram grouping, determining value of a metric based on angles between the principal component vectors associated with one of said reference texts relative to the principal component vectors associated with the other text,
rank ordering said n-gram groupings based on values of the metric corresponding thereto.

26. The method of claim 25, wherein said metric comprises a minimum angle between the principal component vectors of said two texts.

27. The method of claim 25, further comprising assigning a higher rank to an n-gram grouping having a larger minimum angle.

28. The method of claim 27, further comprising selecting one or more n-gram groupings having the highest ranks for processing the text.

29. A system for processing textual data, comprising
a module for determining for each of a plurality of n-gram groupings occurrence frequency distribution corresponding to n-gram members of said grouping for at least two reference texts, wherein one text exhibits an attribute of interest and the other lacks said attribute,
an analysis module receiving said frequency distribution and applying a principal component transformation to said distribution so as to generate a plurality of principal component vectors corresponding to said reference texts for each n-gram grouping,
said analysis module determining for each n-gram grouping a minimum angle between the principal component vectors of said texts corresponding to that grouping,
wherein said analysis module rank orders said n-gram groupings based on the minimal angles corresponding thereto.

30. The system of claim 29, wherein said analysis module is configured to assign a for any two n-gram groupings a higher rank to the grouping having a greater minimum angle.
